(19) United States
(12) Patent Application Publication
(10) Pub. No.: US 2026/0158387 A1
(43) Pub. Date: Jun. 11, 2026

(54) COMPUTER-IMPLEMENTED METHOD FOR ADJUSTING AUDIO OUTPUT BY A VIDEO GAME SYSTEM

(71) Applicant: Sony Interactive Entertainment Inc., Tokyo (JP)

(72) Inventors: Danjeli Schembri, London (GB); Christopher George Buchanan, London (GB); Naoise Tobin, London (GB); Michael Lee Jones, London (GB); Calum Armstrong, London (GB); Alexei Ashton Derek Smith, Bristol (GB)

(21) Appl. No.: 19/355,367

(22) Filed: Oct. 10, 2025

(30) Foreign Application Priority Data
Oct. 11, 2024 (GB) 2415017.9

(51) Int. Cl. A63F 13/54; A63F 13/79; G06F 3/01; G06F 3/16; H04R 25/00

(52) U.S. Cl. CPC A63F 13/54; A63F 13/79; G06F 3/165; H04R 25/505; G06F 3/015; H04R 2430/01

(57) ABSTRACT

Described herein is a computer-implemented method for adjusting audio output by a video game system, the method including: obtaining (110) a user profile indicating a user's hearing requirements; determining (120) audio content of one or more audio components to be output by the video game system; and based on the user profile and the determined audio content, adjusting (130) the one or more audio components to meet the user's hearing requirements.

### CROSS-REFERENCE TO RELATED APPLICATIONS

This application claims priority to U.K. Application Serial No. 2415017.9, filed on Oct. 11, 2024. The disclosure of the prior application is considered part of the disclosure of this application, and is incorporated in its entirety into this application.

### FIELD OF THE INVENTION

The present invention is directed to a computer-implemented method for adjusting audio output by a video game system. In particular, the present invention is directed computer-implemented method for adjusting audio output by a video game system based on a user's hearing requirements.

### BACKGROUND

Audio is a key component of modern video games. Types of audio output in video games include, for example, background music, ambient sounds, sound effects in response to an event in the video game, and voice chat associated with other users playing the same game.

Many video game users are affected by hearing loss, impairment or other hearing accessibility requirements. These factors may affect the user's ability to hear or tolerate certain output audio, thus impacting their enjoyment of the game or their reception to the game.

Users with moderate to severe hearing loss may utilise hearing aids in order to assist their hearing in day-to-day life. These users may have access to an audiogram (a graph that indicates the user's hearing sensitivity for various frequencies) resulting from a formal diagnosis that describes their hearing profile. These users are more likely to have a detailed understanding of their hearing requirements. However, hearing aids are typically incompatible with video gaming systems known in the art.

Users with a hearing impairment caused by aging and/or other factors may not have access to a formal diagnosis. Therefore, these users may not understand their specific hearing requirements.

Users with other hearing accessibility requirements again may not have access to a formal diagnosis. However, these users may have an understanding of audio that is unsuitable for them. For example, they may find certain types of sounds to be anxiety-inducing in comparison to others.

In video games all aspects of the output audio have been selected purposefully. Types of user hearing requirements are wide ranging and can require a number of different user-specific adjustments to satisfy. It can be time consuming for a user to adjust output audio manually, and some users may not be aware of their specific requirements.

Therefore, there exists a need to aid users affected by hearing loss, impairment, or accessibility requirements in the video gaming context.

Additionally, or alternatively, many video game users have specific preferences regarding audio that is output during gameplay. There therefore also exists a need to improve the adjustment of output audio to meet user's preferences.

### SUMMARY

In an aspect, there is provided a computer-implemented method for adjusting audio output by a video game system, the method including: obtaining a user profile indicating a user's hearing requirements; determining audio content of one or more audio components to be output by the video game system; and based on the user profile and the determined audio content, adjusting the one or more audio components to meet the user's hearing requirements.

In this way, audio output by a video game system can be adjusted based on a user's specific hearing requirements. This can improve the user's experience of the video game and improve their reception to the game. The disclosed technology serves to aid users with a wide range of different hearing requirements. Furthermore, the disclosed technology can alleviate the need for a user to manually adjust audio parameters so that the output audio from the video game meets their hearing requirements.

For example, it may be determined that an audio component (background music) includes audio content (a particular frequency) that cannot be heard very well by a user as indicated by their user profile. This audio component can therefore be adjusted accordingly to meet the user's hearing requirements. As a further example, it may be determined that an audio component (a sound effect) includes audio content (an explosion) that may be anxiety-inducing for a user as indicated by their user profile. This audio component can also be adjusted accordingly to meet the user's hearing requirements.

The various methods described herein can be implemented on a video game system running a video game that outputs audio.

Preferably, the user's hearing requirements include the user's hearing profile and/or the user's accessibility requirements and/or the user's preferences. In this way, the user's hearing requirements can be provided in detail. As such, the one or more audio components can be adjusted more accurately to meet the user's hearing profile and/or the user's accessibility requirements and/or the user's preferences. The user profile can include a user's hearing preferences.

The user's hearing profile may detail the user's physical hearing characteristics and the user's accessibility requirements may list or detail audio content that conflicts with the user's hearing requirements.

Preferably, the user profile includes an audiogram. In this way, the user's hearing requirements can be provided in quantitative detail. For example, an audiogram can indicate a user's hearing characteristics or sensitivity for specific frequencies. Additionally, an audiogram can reflect a user's hearing preferences with respect to specific frequencies. The one or more audio components can therefore be adjusted more accurately to meet the user's specific hearing requirements. In particular, the audiogram may define the user's hearing profile and/or the user's accessibility requirements and/or the user's preferences.

In alternative or additional embodiments, the user profile may include a list describing types of sounds, such as explosions or shouting, that do not meet a user's hearing requirements. The user profile may include a list, the list including labels defining properties or categories of audio components that do not meet the user's hearing requirements. For example, a list indicating a user's accessibility requirements may include labels defining “no shouting”, “no explosions”. A list indicating a user's hearing profile or preferences could include a label defining “reduce high frequencies”. In this way, audio components including in the category of shouting or explosions, or with high frequency properties, can be adjusted appropriately either by reducing their output volume or not outputting them altogether to meet the user's hearing requirements.

In various embodiments, obtaining the user profile includes selecting a user profile from a plurality of different premade user profiles, wherein the selected user profile most closely matches the user's hearing requirements.

In this way, a user can select a user profile that most closely matches their own hearing requirements. This is advantageous as a user may not precisely understand their own specific hearing requirements. The user can easily select a premade user profile that they perceive to be best suited to them. This may involve selecting an audiogram that they believe closely resembles their hearing requirements or selecting a list that indicates types of sounds that do not correspond to their hearing preferences.

In various embodiments, obtaining the user profile includes: outputting one or more unadjusted audio components during gameplay; receiving user data in response to the one or more output unadjusted audio components during gameplay to determine whether the one or more output unadjusted audio components meet the user's hearing requirements; and generating the user profile based on the received user data.

In this way, a user profile can be generated or updated specifically for a user based on their response to output audio. A user profile can be automatically generated or updated based on their behaviour and feedback in response to audio output whilst playing the videogame. This is particularly useful if a user does not understand their own hearing requirements. An audiogram may be generated or updated for the user to obtain the user profile. Alternatively, or additionally, a list indicating audio components that do not meet a user's hearing requirements may be generated or updated.

In other terms, if an unadjusted audio component (a sound effect) is output during gameplay that prompts a negative response from the user as indicated by the recorded user data, the user profile can be generated or adjusted accordingly. Subsequent audio components to be output can then be adjusted based on the updated or generated user profile.

Preferably, the user data is received via one or more sensors, the one or more sensors including a heart rate monitor, a blood pressure monitor, an electroencephalography (EEG) sensor and/or an accelerometer. In this way, user data can easily be recorded from the user whilst they are playing the video game. Heart rate monitors, blood pressure monitors, EEG sensors and/or an accelerometer can be worn by a user during gameplay to record data from them in response to output audio. In the case of EEG sensors, these may be provided in a VR headset or headphones worn by the user during gameplay. If an increase in the user's heartrate was recorded in response to the output of a particular sound effect, this would indicate that the sound effect contains audio content that does not meet the user's hearing requirements.

In various embodiments, the user data is received via one or more user inputs. The one or more user inputs may include a video game console power switch and/or a volume adjustment. For example, if a user switches off the video game console running the video game or makes a volume adjustment in response to output audio, this may suggest that the audio output at that instance does not meet the user's hearing requirements. In this way, the user profile can be generated or updated accordingly.

In various embodiments, the user data is received via an input audio sample, the input audio sample including output unadjusted audio components of the one or more output unadjusted audio components that did not meet the user's hearing requirements. In this way, the user can themselves highlight audio content in the output audio that does not meet their hearing requirements. The user profile can then be generated or updated accordingly. As an example, the user may record a portion of the audio output and input this to generate or update their user profile.

In various embodiments, the user profile is obtained by: outputting one or more audio assets; receiving a user response via one or more user interfaces in response to the one or more output audio assets to determine whether the one or more audio assets meet the user's hearing requirements; and generating a user profile based on the received user response.

In this way, a user profile can be generated for user based on their interaction with the user interface in response to the audio assets that are output. This is particularly beneficial if a user does not understand their specific hearing requirements. This aspect of the method described herein may be performed prior to running a video game in an audio calibration stage. The one or more audio assets may be a standard sample sound effect, such as a single note.

Preferably, each of the one or more audio assets is associated with a respective user interface. In this way, a user can interact with a variety of different output audio assets individually so that their user profile can be generated accordingly.

In various embodiments, an audiogram is generated for each of the one or more audio assets, each audiogram defining the user profile with respect to a respective audio asset. The audiogram can quantitively indicate a user's hearing characteristics or sensitivity for specific frequencies. In particular, the audiogram may define the user's hearing profile and/or the user's accessibility requirements and/or the user's preferences.

In various embodiments, the one or more user interfaces adjust the one or more output audio assets. In this way, the user can receive feedback in the format of adjusted output audio in response to interacting with the user interface. This is advantageous as they can interact with the user interface until they perceive the output audio assets meet their hearing requirements.

In various embodiments, each of the one or more audio components includes a label indicating a property or a category of the respective audio component, and wherein adjusting the one or more audio components includes adjusting, replacing, or removing an audio component based on the respective label. In this way, if a user's profile indicates that certain audio content does not meet their hearing requirements, audio components including that content can be adjusted, replaced or removed so that the user's hearing requirement can be met.

Preferably, the labels of the one or more audio components are compared with the user profile to determine whether an audio component should be adjusted, replaced, or removed. For example, if a sound effect is labelled “explosion” and a user profile indicates that explosions do not meet the user's hearing requirements, this sound effect can be removed so that it is not output.

Preferably, the labels of the one or more audio components are compared with a list including labels defining properties or categories of audio components that do not meet the user's hearing requirements to determine whether an audio component should be adjusted, replaced, or removed.

A particular audio component may be assigned a label indicating that it is an explosion. If the user profile includes a list with a label indicating that explosions do not meet the user's hearing requirements, then the outputting of this sound effect can be prevented. In this way, if it is determined that the properties (e.g. frequencies) or categories (e.g. shouting or explosions) of the audio components do not meet the user's hearing requirements based on the comparison, the properties can be adjusted, or audio components of a particular category can be removed.

In various embodiments, adjusting the one or more audio components includes: analysing the one or more audio components to determine one or more properties of the one or more audio components; comparing the one or more properties of the one or more audio components with the user profile; and adjusting the one or more properties of the one or more audio components based on the comparison.

Preferably, analysing the one or more audio components to determine one or more properties of the one or more audio components includes categorising similar audio components of the one or more audio components. Preferably, the categorising of similar audio components of the one or more audio components is performed using a machine-learning approach.

In various embodiments, adjusting the one or more audio components includes: adjusting volume; adjusting frequency; adjusting duration; and/or applying a style transfer function using a neural network.

In various embodiments, adjusting the one or more audio components includes applying a boost curve to the one or more audio components, wherein the boost curve includes a plurality of frequency dependent gain values for compensating for the user profile. In particular, this may compensate for a user's hearing profile as indicated by an audiogram, for example. The gain value may be positive or negative to meet the user's hearing requirements for any given frequency. A boost curve may be applied based on the properties of the one or more audio components to be output, determined based on analysing the one or more audio components, and the user's hearing requirements. Preferably, the properties include a loudness value of the respective frequencies of the audio component to be output. A frequency dependent gain value may be calculated for each frequency in the audio component to be output. A suitable boost curve may be formed by combining one or more audio adjustment filters.

In various embodiments, determining audio content of one or more audio components to be output by the video game system and/or adjusting the one or more audio components to meet the user's hearing requirements occurs during gameplay or prior to gameplay.

### BRIEF DESCRIPTION OF DRAWINGS

Embodiments of the disclosed technology will now be described, by way of example, by reference to the drawings, in which:

FIG. 1 is a flow diagram of an example computer-implemented method for adjusting audio output by a video game system;

FIG. 2 is a flow diagram of an example computer-implemented method for obtaining a user profile indicating a user's hearing requirements by a video game system ;

FIG. 3 is a flow diagram of an example computer-implemented method for obtaining a user profile indicating a user's hearing requirements by a video game system ;

FIG. 4A depicts three example audiograms indicating hearing profiles of users with mild, moderate and strong hearing loss respectively; and

FIG. 4B depicts three example audiograms indicating hearing profiles of users with mild, moderate and strong hearing impairment, or hearing accessibility requirements respectively.

### DETAILED DESCRIPTION

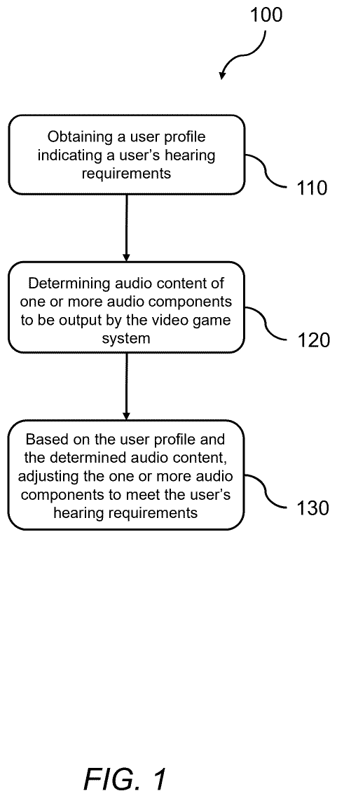

FIG. 1 is a flow diagram of a computer-implemented method 100 for adjusting audio output by a video game system. The method 100 includes the steps of: obtaining a user profile indicating a user's hearing requirements 110; determining audio content of one or more audio components to be output by the video game system 120; and based on the user profile and the determined audio content, adjusting the one or more audio components to meet the user's hearing requirements 130.

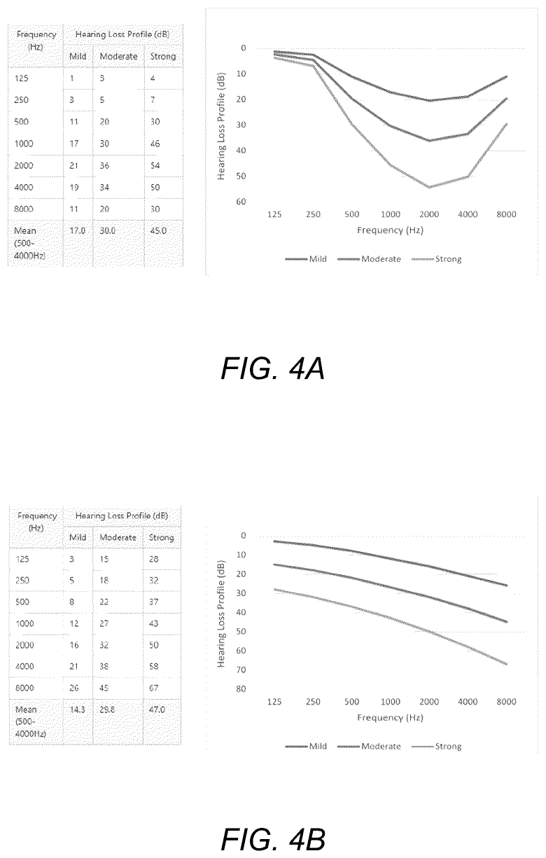

The user profile indicates the user's physical hearing profile, other hearing accessibility requirements, and/or listening preferences in the form of an audiogram, such as those depicted in FIGS. 4A and 4B. Alternatively, or additionally, the user profile includes a list indicating types of sounds that do not meet the user's hearing requirements.

The user profile may be obtained in variety of ways, as will be described herein. In an extension to step 110 of this embodiment, the user profile is obtained by selecting a premade user profile from a number of different user profiles. This involves a user selecting a hearing profile from a list of hearing profiles that they believe most closely matches their own hearing requirements. For example, if a user suffers from hearing loss and struggles to hear frequencies associated with human conversation, they can select a hearing profile accordingly that will indicate that the volume of these frequencies should be increased in the output audio. As a further example, if a user has a hearing accessibility requirement whereby they find explosions anxiety-inducing, they can select a hearing profile accordingly that will indicate to remove explosions from the output audio of the videogame system. If a user has a listening preference to not hear high-pitched sounds, they can select a user profile that reflects this.

Once the user profile has been obtained at step 110, audio content of one or more audio components to be output by the video game system is determined at step 120. This can involve analysing the audio components, which include background music and voice chat, to identify particular frequencies or other audio content associated with the audio components.

The audio components can be grouped into categories based on common audio content shared between them. This may be done using a machine-learning approach, which determines similarities between audio components and groups them together accordingly.

The determined audio content is compared with the obtained user profile to decide if the audio content meets the user's hearing requirements or not. If the user profile indicates that the audio content would not meet the user's hearing requirements, e.g. the audio content is a frequency that the user cannot hear very well, the audio component can be adjusted to increase the volume of that frequency. Conversely, if the audio content is a frequency that the user does not want to hear, the audio component can be adjusted to decrease the volume of that frequency.

In an embodiment, the audio components to be output include labels indicating their content or properties. For example, an audio component such as a sound effect may include a label indicating “high-pitched” or “explosion”. Depending on the user profile, the labelled audio component can be adjusted, replaced or removed as appropriate. If the user profile indicates that the sound of explosions does not meet the user's hearing accessibility requirements, a sound effect of an explosion can either be removed from the audio to be output or replaced with a different sound effect.

In the various embodiments described herein, adjusting the one or more audio components to meet the user's hearing requirements 130 includes adjusting volume, frequency, and/or duration of the audio components.

The one or more audio components can be adjusted by applying a boost curve which includes a plurality of frequency dependent gain values for compensating for a user's profile as indicated by an audiogram. Specific frequencies within the audio components can therefore be boosted or decreased in loudness depending on the shape of the boost curve.

In the context of audio components including human speech, adjusting these audio components can include applying a style transfer function using a neural network to modify the human speech to meet the user's hearing requirements. The user profile may indicate that shouting or certain styles of voice do not meet the user's hearing requirements. In this case, a style transfer function can be applied to alter the human speech in the audio component.

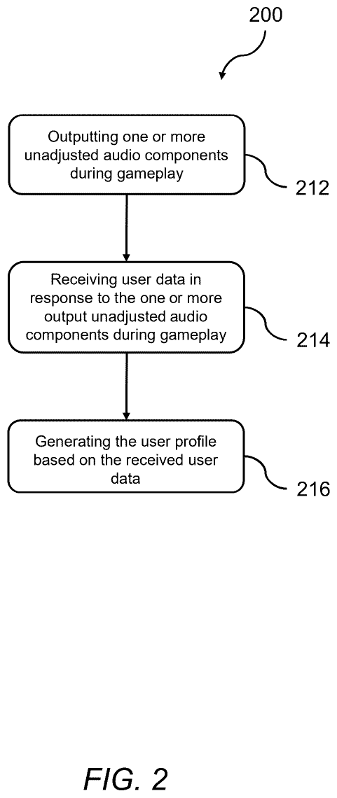

FIG. 2 is a flow diagram of a computer-implemented method 200 for obtaining a user profile indicating a user's hearing requirements by a video game system. In particular, the method 200 can form part of the method 100 in the example shown in FIG. 1.

The method 200 includes the steps of: outputting one or more unadjusted audio components during gameplay 212; receiving user data in response to the one or more output unadjusted audio components during gameplay to determine whether the one or more output unadjusted audio components meet the user's hearing requirements 214; and generating the user profile based on the received user data 216.

The one or more unadjusted audio components can be considered to be the standard audio associated with the video game that is output during gameplay. It has not yet been adjusted in order to meet the user's hearing requirements. The unadjusted audio components may therefore not meet a user's hearing requirements and may therefore need adjusting.

The user data can be recorded in several ways in order to generate the user profile. The user data can be recorded via a heart rate monitor, a blood pressure monitor, an electroencephalography (EEG) sensor and/or an accelerometer. If one of these sensors were to detect a change in the user's physiology in response to a particular unadjusted audio component being output, such as a sound effect, this would suggest that the sound effect does not meet the user's hearing requirements. The user profile can be generated to indicate that the sound effect does not meet the user's hearing requirements, either by changing the profile of an audiogram or appending a description of the sound effect to a list.

Additionally, or alternatively, the user data can be received via a user input such as a video game system power switch or a volume adjustment input. If a user were to switch off the video game system running the video game and outputting the unadjusted audio components in response to a particular unadjusted audio component being output, this would suggest that the sound effect does not meet the user's hearing requirements. Likewise, if a user were to reduce the volume of the unadjusted audio being output by the video game system running the video game in response to a particular unadjusted audio component being output, this would suggest that the sound effect does not meet the user's hearing requirements. The user profile can be generated to indicate that the sound effect does not meet the user's hearing requirements, either by changing the profile of an audiogram or appending a description of the sound effect to a list.

Additionally, or alternatively, the user can themselves record sections of the unadjusted output audio that they perceive not to meet their hearing requirements. They can input this recorded audio sample, and the user profile can be generated to indicate that the sample does not meet the user's hearing requirements, either by changing the profile of an audiogram or appending a description of the sample to a list.

As described above, generating the user profile based on the received user data 216 may include generating or adjusting an audiogram such as those depicted in FIGS. 4A and 4B and/or a list of sounds that do not meet the user's hearing requirements.

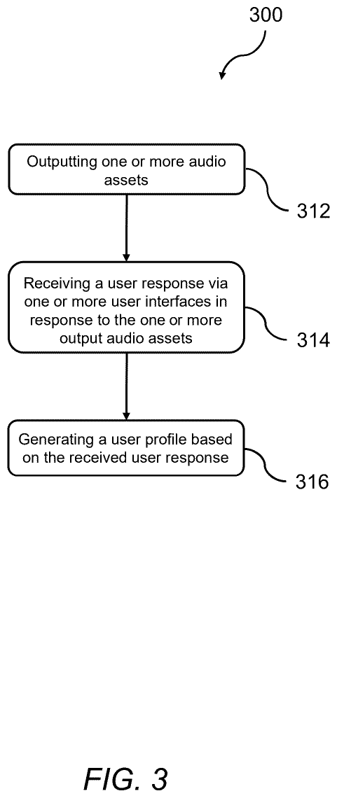

FIG. 3 is a flow diagram of a computer-implemented method 300 for obtaining a user profile indicating a user's hearing requirements by a video game system. In particular, the method 300 can form part of the method 100 shown in FIG. 1.

The method 300 includes the steps of: outputting one or more audio assets 312; receiving a user response via one or more user interfaces in response to the one or more output audio assets to determine whether the one or more audio assets meet the user's hearing requirements 314; and generating a user profile based on the received user response 316.

The one or more audio assets can be considered as sample audio not directly associated with a video game. Instead, the one or audio assets are used to help a user to calibrate their user profile. The method 300 may therefore be performed prior to a user launching a video game.

Each audio asset is associated with a respective user interface, such as a slider that a user can manipulate. The user interface adjusts the audio asset associated with it when it is manipulated by the user. The user can therefore manipulate the user interface until they perceive the output audio asset to be acceptable to them.

For example, a first audio asset could be associated with human speech, and a second audio asset could be associated with a high-pitched sound effect. The user interface associated with each of these assets could adjust their output volumes or another property of the audio asset. The user can therefore adjust each asset until they can hear them clearly. A user may be able to hear one asset more clearly than another depending on their hearing requirements.

Based in the received user response via the user interfaces, an audiogram such of those depicted in FIGS. 4A and 4B can be generated to generate a user profile. Alternatively, an audiogram can be selected from a preset audiogram that most closely matches a user profile indicated by the user inputs to the user interfaces. For example, one of the three audiograms depicted in FIG. 4A or 4B may be selected.

In particular, an audiogram may be generated for each audio asset output to the user. Audio components to be output in the video game corresponding to each of the audio assets can then be adjusted based on the user's inputs.

FIG. 4A depicts three exemplary audiograms indicating hearing profiles of users with mild, moderate and strong hearing loss respectively, whereas FIG. 4B depicts three exemplary audiograms indicating hearing profiles of users with mild, moderate and strong hearing impairment or hearing accessibility requirements respectively. The audiograms depicted in FIGS. 4A and 4B represent those that may be obtained or generated in the various methods described herein.

The exemplary audiograms depicted in FIGS. 4A and 4B are plots of a user's hearing loss profile in decibels at different frequencies in Hertz. A higher hearing loss profile value indicates more significant hearing loss are more significant hearing accessibility requirements. A hearing loss profile value of 20 dB at 500 Hz suggests that a user hears sounds at 500 Hz 20 dB more quietly than a user without hearing loss. It would equally suggest that a user needs to hear sounds at 500 Hz 20 dB more loudly in order for their hearing accessibility requirements to be met.

A user with hearing loss would most likely present an audiogram similar in nature to those depicted in FIG. 4A, whereas a user with a hearing impairment would present an audiogram similar in nature to those depicted in FIG. 4B.

The various methods described herein may be performed during gameplay or prior to gameplay.

1. A computer-implemented method for adjusting audio output by a video game system, the method comprising:
obtaining a user profile indicating a user's hearing requirements;
determining audio content of one or more audio components to be output by the video game system; and
based on the user profile and the determined audio content, adjusting the one or more audio components to meet the user's hearing requirements.

2. The computer-implemented method of claim 1, wherein the user's hearing requirements comprise the user's hearing profile and/or the user's accessibility requirements.

3. The computer-implemented method of claim 1, wherein the user profile comprises an audiogram.

4. The computer-implemented method of claim 1, wherein the user profile comprises a list, the list comprising labels defining properties or categories of audio components that do not meet the user's hearing requirements.

5. The computer-implemented method of claim 1, wherein obtaining the user profile comprises selecting a user profile from a plurality of different premade user profiles, wherein the selected user profile most closely matches the user's hearing requirements.

6. The computer-implemented method of claim 1, wherein obtaining the user profile comprises:
outputting one or more unadjusted audio components during gameplay;
receiving user data in response to the one or more output unadjusted audio components during gameplay to determine whether the one or more output unadjusted audio components meet the user's hearing requirements; and
generating the user profile based on the received user data.

7. The computer-implemented method of claim 6, wherein the user data is received via one or more sensors, the one or more sensors comprising a heart rate monitor, a blood pressure monitor, an electroencephalography sensor and/or an accelerometer.

8. The computer-implemented method of claim 6, wherein the user data is received via one or more user inputs, the one or more user inputs comprising a video game system power switch and/or a volume adjustment input.

9. The computer-implemented method of claim 6, wherein the user data is received via an input audio sample, the input audio sample comprising output unadjusted audio components of the one or more output unadjusted audio components that did not meet the user's hearing requirements.

10. The computer-implemented method of claim 1, wherein the user profile is obtained by:
outputting one or more audio assets;
receiving a user response via one or more user interfaces in response to the one or more output audio assets to determine whether the one or more audio assets meet the user's hearing requirements; and
generating a user profile based on the received user response.

11. The computer-implemented method of claim 10, wherein each of the one or more audio assets is associated with a respective user interface.

12. The computer-implemented method of claim 10, wherein an audiogram is generated for each of the one or more audio assets, each audiogram defining the user profile with respect to a respective audio asset.

13. The computer-implemented method of claim 10, wherein the one or more user interfaces adjust the one or more output audio assets.

14. The computer-implemented of claim 1, wherein each of the one or more audio components comprises a label indicating a property or a category of the respective audio component, and wherein adjusting the one or more audio components comprises adjusting, replacing, or removing an audio component based on the respective label.

15. The computer-implemented method of claim 14, wherein the labels of the one or more audio components are compared with the user profile to determine whether an audio component should be adjusted, replaced, or removed.

16. The computer-implemented method of claim 15, wherein the labels of the one or more audio components are compared with a list comprising labels defining properties or categories of audio components that do not meet the user's hearing requirements to determine whether an audio component should be adjusted, replaced, or removed.

17. The computer-implemented method of claim 1, wherein adjusting the one or more audio components comprises:
analysing the one or more audio components to determine one or more properties of the one or more audio components;
comparing the one or more properties of the one or more audio components with the user profile; and
adjusting the one or more properties of the one or more audio components based on the comparison.

18. The computer-implemented method of claim 17, wherein analysing the one or more audio components to determine one or more properties of the one or more audio components comprises categorising similar audio components of the one or more audio components.

19. The computer-implemented method of claim 18, wherein the categorising of similar audio components of the one or more audio components is performed using a machine-learning approach.

20. The computer-implemented method of claim 1, wherein adjusting the one or more audio components comprises:
adjusting output volume;
adjusting loudness
adjusting frequency;
adjusting duration; and/or
applying a style transfer function using a neural network.

21. The computer-implemented method of claim 1, wherein adjusting the one or more audio components comprises applying a boost curve to the one or more audio components, wherein the boost curve comprises a plurality of frequency dependent gain values for compensating for the user profile.

22. The computer-implemented method of claim 1, wherein determining audio content of one or more audio components to be output by the video game system and/or adjusting the one or more audio components to meet the user's hearing requirements or preferences occurs during gameplay or prior to gameplay.
